(19) United States
(12) Patent Application Publication
(10) Pub. No.: US 2026/0320762 A1
(43) Pub. Date: Oct. 15, 2026

(54) IMAGE ADJUSTING METHOD AND IMAGE ADJUSTING DEVICE

(71) Applicant: REALTEK SEMICONDUCTOR CORPORATION, HSINCHU (TW)

(72) Inventors: YEN LIU, HSINCHU (TW); WEN-TSUNG HUANG, HSINCHU (TW); CHI-JUNG CHEN, HSINCHU (TW)

(21) Appl. No.: 19/643,018

(22) Filed: Apr. 9, 2026

(30) Foreign Application Priority Data
Apr. 10, 2025 (TW) 114113604

(51) Int. Cl. G06T 5/92; G06T 3/40; G06T 5/40; G06T 5/70; G06T 7/136; G06T 7/194; G06T 7/50

(52) U.S. Cl. CPC G06T 5/92; G06T 3/40; G06T 5/40; G06T 5/70; G06T 7/136; G06T 7/194; G06T 7/50; G06T 2207/10024; G06T 2207/20084; G06T 2207/20182; G06T 2207/30201

(57) ABSTRACT

The present disclosure provides an image adjusting method which is executed by a processor. The image adjusting method includes: providing a depth map; performing an aerial perspective image enhancement algorithm on the depth map to generate an aerial perspective enhanced image; performing a foreground and background image statistic on an input image and the depth map to generate a foreground image statistic value and a background image statistic value; and performing a depth statistical image enhancement algorithm on the aerial perspective enhanced image, the foreground image statistic value, and the background image statistic value to generate an output image.

### BACKGROUND OF THE INVENTION

### 1. Field of the Invention

The present disclosure relates to an image adjusting method and an image adjusting device, especially to an image adjusting method and an image adjusting device for optimizing an output image.

### 2. Description of Related Art

Traditional statistical methods for image quality tuning mostly fall into two directions, such as global statistical values and facial statistical values. Under scenarios with non-single light sources or complex scenes, if the above traditional statistical methods are adopted, brightness and color effects of different regions within a scene cannot be simultaneously taken into consideration.

Taking color as an example, a user usually adjusts a skin tone in an image to be relatively reddish. However, performing skin tone adjustment processing in a complex light source scene may instead cause a color cast problem of the image. For example, in a backlight scene, light sources include sunlight outside a window and indoor lighting. If adjustment processing is performed according to a skin tone, color cast problems of the sky and trees outside the window will be caused.

### SUMMARY OF THE INVENTION

In some aspects, an object of the present disclosure is to, but not limited to, provides an image adjusting method and an image adjusting device that makes an improvement to the prior art.

An embodiment of an image adjusting method of the present disclosure includes: providing a depth map; performing an aerial perspective image enhancement algorithm on the depth map to generate an aerial perspective enhanced image; performing a foreground and background image statistic on an input image and the depth map to generate a foreground image statistic value and a background image statistic value; and performing a depth statistical image enhancement algorithm on the aerial perspective enhanced image, the foreground image statistic value, and the background image statistic value to generate an output image.

An embodiment of an image adjusting device of the present disclosure includes a processor. The processor is configured to execute at least one command to: provide a depth map; perform an aerial perspective image enhancement algorithm on the depth map to generate an aerial perspective enhanced image; perform a foreground and background image statistic on an input image and the depth map to generate a foreground image statistic value and a background image statistic value; and perform a depth statistical image enhancement algorithm on the aerial perspective enhanced image, the foreground image statistic value, and the background image statistic value to generate an output image.

Technical features of some embodiments of the present disclosure make an improvement to the prior art. The image adjusting method and the image adjusting device of the present disclosure can adopt an aerial perspective image enhancement algorithm to stereoscopically enhance a foreground region (e.g., a portrait) and to render a background region as distant, such that the foreground region (e.g., the portrait) is visually further stereoscopic and vivid. Furthermore, the image adjusting method and the image adjusting device of the present disclosure can adopt a depth statistical image enhancement algorithm to prevent a single statistical value from being applied to an entire frame of an input image, thereby causing an image deviation problem.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of an image adjusting device of the present disclosure.

FIG. 2 shows an embodiment of a flow diagram of an image adjusting method of the present disclosure.

FIG. 3 shows an embodiment of a flow diagram of generating a depth map of the present disclosure.

FIG. 4 shows an embodiment of a flow diagram of generating a spatial perspective enhanced image of the present disclosure.

FIG. 5A shows an embodiment of a schematic diagram of an input image of the present disclosure.

FIG. 5B shows an embodiment of a schematic diagram of a spatial perspective enhanced image of the present disclosure.

FIG. 6A shows an embodiment of a schematic diagram of an input image of the present disclosure.

FIG. 6B shows an embodiment of a schematic diagram of a spatial perspective enhanced image of the present disclosure.

FIG. 7A shows an embodiment of a schematic diagram of an input image of the present disclosure.

FIG. 7B shows an embodiment of a schematic diagram of a spatial perspective enhanced image of the present disclosure.

FIG. 8 shows an embodiment of a flow diagram of generating foreground and background image statistical values of the present disclosure.

FIG. 9A shows an embodiment of a schematic diagram of a depth map of the present disclosure.

FIG. 9B shows an embodiment of a schematic diagram of a customized depth image of the present disclosure.

FIG. 10A shows an embodiment of a schematic diagram of a depth map of the present disclosure.

FIG. 10B shows an embodiment of a schematic diagram of a customized depth image of the present disclosure.

FIG. 11 shows an embodiment of a flow diagram of generating an output image of the present disclosure.

FIG. 12A shows an embodiment of a schematic diagram of an input image of the present disclosure.

FIG. 12B shows an embodiment of a schematic diagram of a depth statistical enhanced image of the present disclosure.

FIG. 13A shows an embodiment of a schematic diagram of an input image of the present disclosure.

FIG. 13B shows an embodiment of a schematic diagram of an output image with automatic exposure control of the present disclosure.

FIG. 14A shows an embodiment of a schematic diagram of an input image of the present disclosure.

FIG. 14B shows an embodiment of a schematic diagram of an output image with automatic exposure control of the present disclosure.

### DETAILED DESCRIPTION OF THE PREFERRED EMBODIMENTS

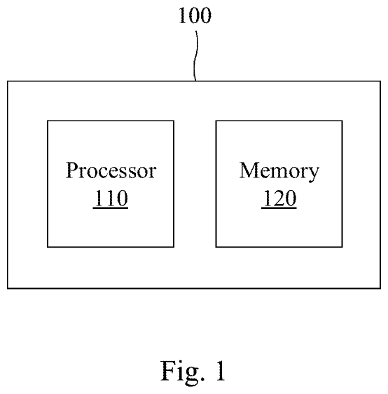

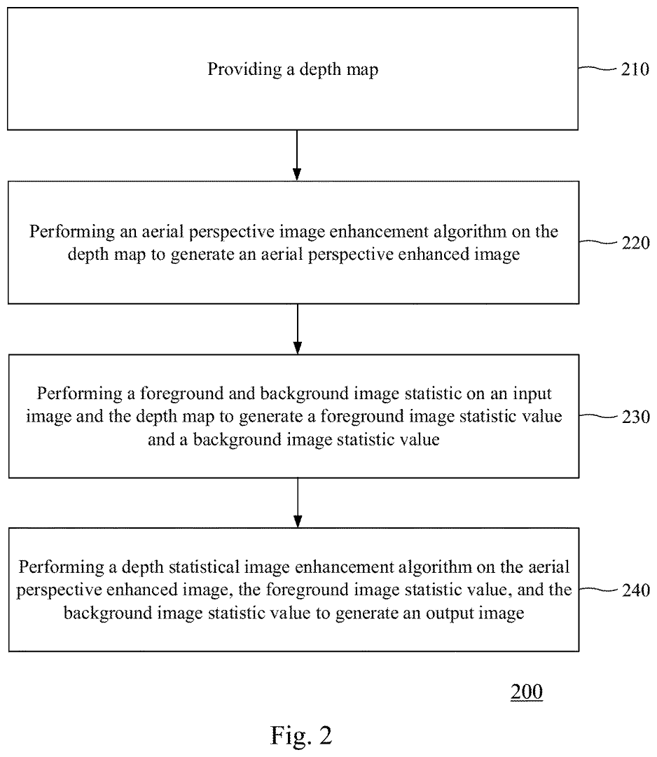

FIG. 1 shows an embodiment of an image adjusting device 100 of the present disclosure. As shown in the figure, the image adjusting device 100 includes a processor 110 and a memory 120. The memory 120 is configured to store at least one command. The processor 110 is configured to read the at least one command to execute an image tuning process. To make the operation of the image adjusting device 100 easy to understand, please also refer to FIG. 2, wherein FIG. 2 shows an embodiment of a flow diagram of an image adjusting method 200 of the present disclosure.

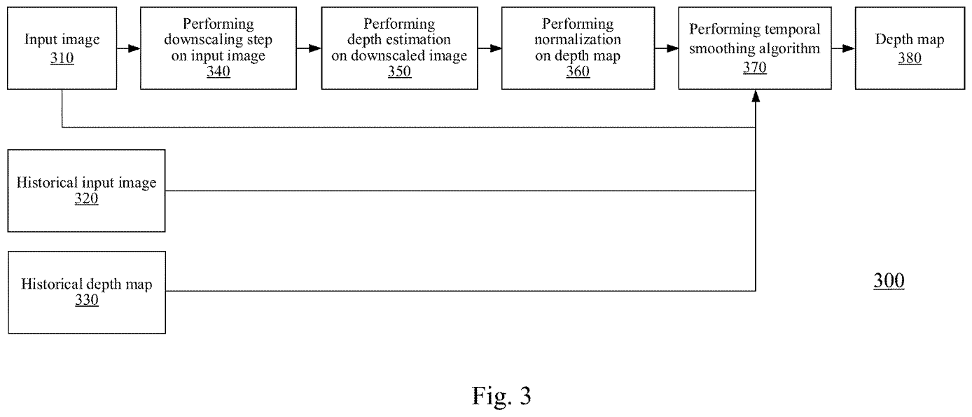

Referring to step 210 of FIG. 2, providing a depth map. For example, referring to step 310 of FIG. 3, providing an input image, such as providing an input image of a current frame. Referring to step 320 of FIG. 3, providing a historical input image. Referring to step 330 of FIG. 3, providing a historical depth map. Referring to step 340 of FIG. 3, performing a downscaling step on the input image to generate a downscaled image. For example, the present disclosure can adopt bilinear difference to downscale the input image, and a width and a height of the downscaled image after downscaling can be 256*160. However, the present disclosure is not limited to the above embodiments. In other embodiments, the downscaling manner can adopt other suitable techniques, and the width and the height of the downscaled image can adopt other suitable values according to actual requirements.

Referring to step 350 of FIG. 3, performing a depth estimation on the downscaled image to generate a depth map. For example, the present disclosure can adopt a neural network to execute depth estimation, and depth values of the depth map output by the neural network can be 0~FLOAT_MAX. Referring to step 360 of FIG. 3, performing a normalization on the depth map such that the depth map is within a numerical range. For example, the present disclosure can adopt the depth estimation neural network to execute a normalization, and a formula is as follows:

$$DepthMap = \frac{( DepthMap - min ( DepthMap ) )}{max ( DepthMap ) - min ( DepthMap )} \qquad Formula 1$$

Referring to Formula 1, DepthMap is the depth map, and depth values of the depth map output by the neural network can be 0~FLOAT_MAX. Through normalization using Formula 1, the depth map is within 0~255. However, the present disclosure is not limited to the above embodiments. In other embodiments, numerical values for normalization can adopt other suitable values according to actual requirements.

Referring to step 370 of FIG. 3, performing a temporal smoothing algorithm on the depth map according to the historical input image and the historical depth map. In step 380, outputting the depth map. For example, the depth estimation neural network of the present disclosure adopts single-frame prediction and executes a temporal smoothing algorithm between frames. Inputs of the temporal smoothing algorithm are an input image of a current frame, together with a historical input image and a historical depth map, to calculate pixel value differences between frames (e.g., RGB or YUV color spaces), thereby defining a dynamic region and a static region. Subsequently, the present disclosure executes averaging of depth map values in the static region, while for the dynamic region, a depth map of the current frame is further updated according to pixel value differences. It should be noted that, if the image adjusting device 100 is applied to a depth camera composed of dual cameras, a depth map generated by the depth camera can be directly adopted without the above depth map generation related steps 310~380, and the subsequent image enhancement related algorithms of the present disclosure can be used.

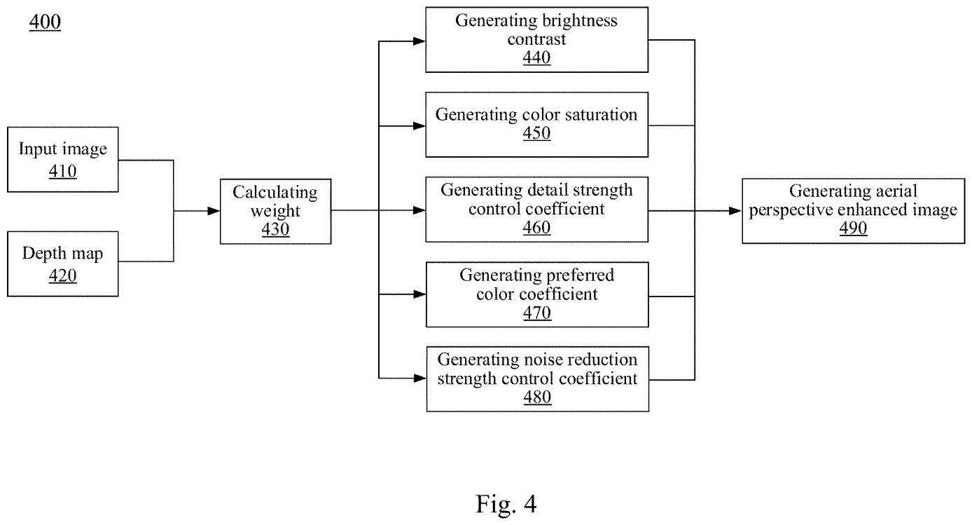

Please refer back to FIG. 2. Referring to step 220 of FIG. 2, performing an aerial perspective image enhancement algorithm on the depth map to generate an aerial perspective enhanced image. For example, referring to step 410 of FIG. 4, providing an input image. Referring to step 420 of FIG. 4, providing a depth map. Referring to step 430 of FIG. 4, calculating a weight according to the depth map, and a formula is as follows:

W_{depth}(i)=W_{transform}(Depth Map(i)) Formula 2

W_{transform}=α*Depth Map+β Formula 3

As shown in Formulas 2 and 3, W_{depth}(i) is the weight, W_{transform} is a transformation formula, Depth Map(i) is the depth map, and a and p are parameters. For example, a near scene has a higher weight, and a far scene has a lower weight. However, the present disclosure is not limited to the above embodiments, which are merely used to illustratively describe one implementation manner of the present disclosure.

Referring to step 440 of FIG. 4, generating a brightness contrast according to the weight, a local brightness map of the input image, and a brightness and contrast enhancement curve, and a formula is as follows:

Yₒᵤₜ(i)=W_{depth}(i)*B_{local}(Yᵢₙ(i))*BC_{curve}(Yᵢₙ(i)) Formula 4

As shown in Formula 4, Yₒᵤₜ(i) is the brightness contrast, W_{depth}(i) is the weight, B_{local} is the local brightness map, Yᵢₙ(i) is the input brightness, and BC_{curve} is the brightness and contrast enhancement curve. However, the present disclosure is not limited to the above embodiments, which are merely used to illustratively describe one implementation manner of the present disclosure.

Referring to step 450 of FIG. 4, generating a color saturation according to the weight, a saturation scaling coefficient, and a color component of the input image, and a formula is as follows:

UVₒᵤₜ=W_{depth}(i)*Scaleₛₐₜᵤᵣₐₜᵢₒₙ*UV(i) Formula 5

As shown in Formula 5, UVₒᵤₜ is the color saturation, W_{depth}(i) is the weight, Scaleₛₐₜᵤᵣₐₜᵢₒₙ is the saturation scaling coefficient, and UV(i) is the color component of the input image. However, the present disclosure is not limited to the above embodiments, which are merely used to illustratively describe one implementation manner of the present disclosure.

Referring to step 460 of FIG. 4, generating a detail strength control coefficient according to the brightness contrast, the weight, a texture scaling coefficient, and a brightness difference of the input image, and a formula is as follows:

Yₒᵤₜ₁=Yₒᵤₜ₂+W_{depth}(i)*Scaleₜₑₓₜᵤᵣₑ*(Yᵢₙ−B_{local}) Formula 6

As shown in Formula 6, Yₒᵤₜ₁ is the detail strength control coefficient, Yₒᵤₜ₂ is the brightness contrast, W_{depth}(i) is the weight, Scaleₜₑₓₜᵤᵣₑ is the texture scaling coefficient, (Yᵢₙ−B_{local}) is the brightness difference of the input image, Yᵢₙ is the input brightness, and B_{local} is the local brightness map. However, the present disclosure is not limited to the above embodiments, which are merely used to illustratively describe one implementation manner of the present disclosure.

In some embodiments, referring to step 490 of FIG. 4, generating an aerial perspective enhanced image according to the brightness contrast, the color saturation, and the detail strength control coefficient. For example, based on an aerial perspective or atmospheric perspective principle, a foreground region closer to a user is a region with stronger visual perception for the user, wherein a region where a portrait is located is a primary focus. To stereoscopically enhance the foreground region (e.g., the portrait), the aerial perspective image enhancement algorithm refers to the depth map and enhances a plurality of image parameters of the foreground region. The above image parameters can include the brightness contrast, the color saturation, and the detail strength control coefficient (corresponding to detail richness), and so on. Conversely, a plurality of image parameters of a background region can be reduced to achieve a distant-view effect of spatial perspective perception. The above image parameters can include the brightness contrast, the color saturation, and the detail strength control coefficient (corresponding to detail richness), and so on.

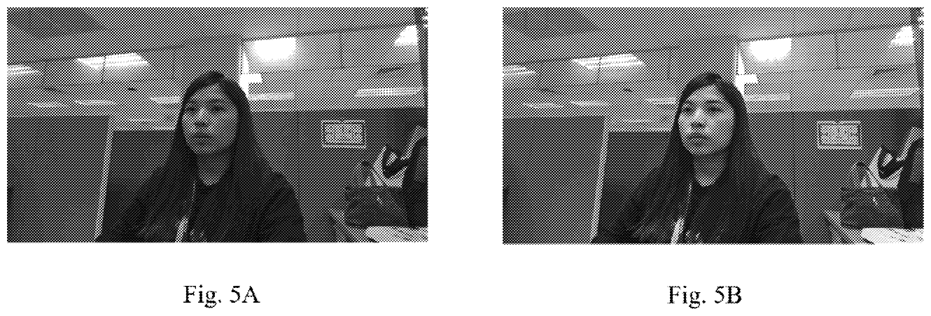

FIG. 5A shows an embodiment of a schematic diagram of an input image according to some embodiments of the present disclosure. FIG. 5B shows an embodiment of a schematic diagram of an aerial perspective enhanced image according to some embodiments of the present disclosure. Referring to FIG. 5A and FIG. 5B, FIG. 5B tunes the brightness contrast of a foreground region (e.g., a portrait) in the input image of FIG. 5A. As can be seen from FIG. 5B, after the brightness contrast of the foreground region (e.g., the portrait) is enhanced, the portrait is visually further stereoscopic and vivid, and the portrait is not excessively dark due to backlight.

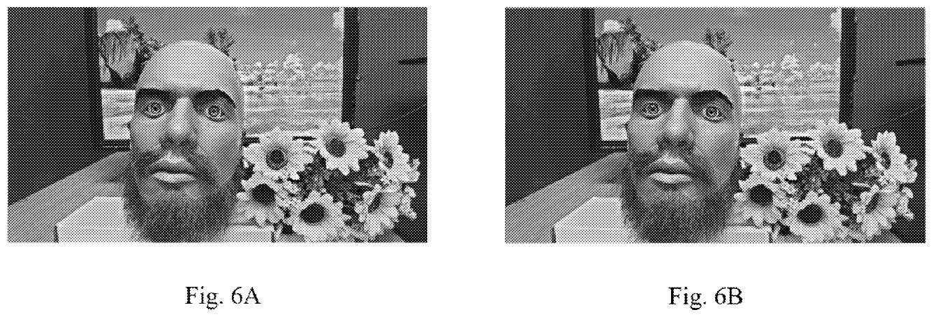

FIG. 6A shows an embodiment of a schematic diagram of an input image of the present disclosure. FIG. 6B shows an embodiment of a schematic diagram of a spatial perspective enhanced image of the present disclosure. Referring to FIG. 6A and FIG. 6B, FIG. 6B tunes the color saturation of a foreground region (e.g., a portrait) in the input image of FIG. 6A. As can be seen from FIG. 6B, after the color saturation of the foreground region (e.g., the portrait) is enhanced, the portrait is visually further stereoscopic and vivid, thereby allowing a user's visual attention to be further focused on the portrait.

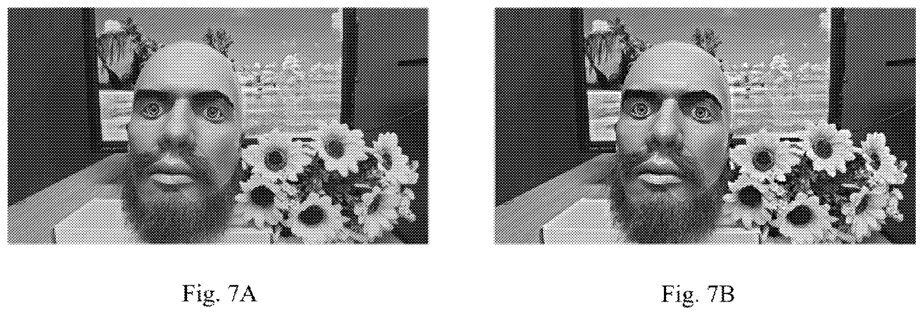

FIG. 7A shows an embodiment of a schematic diagram of an input image of the present disclosure. FIG. 7B shows an embodiment of a schematic diagram of a spatial perspective enhanced image of the present disclosure. Referring to FIG. 7A and FIG. 7B, FIG. 7B tunes the detail strength control coefficient of a foreground region (e.g., a portrait) in the input image of FIG. 7A. As can be seen from FIG. 7B, after details of the foreground region (e.g., the portrait) are enhanced, the portrait is visually further stereoscopic and vivid.

Referring to step 470 of FIG. 4, further generating a preferred color coefficient according to the weight, a style color offset scaling coefficient, and a color component of the input image, and a formula is as follows:

UVₒᵤₜ=W_{depth})*Scale_{style color offset}*UV(i) Formula 7

As shown in Formula 7, UVₒᵤₜ is the preferred color coefficient, W_{depth}(i) is the weight, Scale_{style color offset} is the style color offset scaling coefficient, and UV(i) is the color component of the input image. However, the present disclosure is not limited to the above embodiments, which are merely used to illustratively describe one implementation manner of the present disclosure.

Referring to step 480 of FIG. 4, further generating a noise reduction strength control coefficient according to a maximum depth value of the depth map, the weight, a strong noise reduction color space parameter, and a weak noise reduction color space parameter, and a formula is as follows:

YUVₒᵤₜ=(Depth_{Max}−W_{depth})*Denoise(YUVᵢₙ,Param_{strong})+W_{depth}*Denoise(YUVᵢₙ,Param_{weak}) Formula 8

As shown in Formula 8, YUVₒᵤₜ is the noise reduction strength control coefficient, Depth_{Max} is the maximum depth value, W_{depth} is the weight, YUVᵢₙ is the color space parameter, Denoise(YUVᵢₙ, Param_{strong}) is performing strong noise reduction on the color space parameter to generate the strong noise reduction color space parameter, and Denoise(YUVᵢₙ,Param_{weak}) is performing weak noise reduction on the color space parameter to generate the weak noise reduction color space parameter. However, the present disclosure is not limited to the above embodiments, which are merely used to illustratively describe one implementation manner of the present disclosure.

In some embodiments, referring to step 490 of FIG. 4, further generating an aerial perspective enhanced image according to the brightness contrast, the color saturation, the detail strength control coefficient, the above preferred color coefficient, and the above noise reduction strength control coefficient. To stereoscopically enhance a foreground region (e.g., a portrait), the aerial perspective image enhancement algorithm refers to the depth map and enhances a plurality of image parameters of the foreground region. In addition to the brightness contrast, the color saturation, and the detail strength control coefficient (corresponding to detail richness), the above image parameters further include the preferred color coefficient and the noise reduction strength control coefficient. Conversely, a plurality of image parameters of a background region can be reduced to achieve a distant-view effect of spatial perspective perception. The above image parameters of the background region likewise, in addition to the brightness contrast, the color saturation, and the detail strength control coefficient (corresponding to detail richness), further include the preferred color coefficient and the noise reduction strength control coefficient.

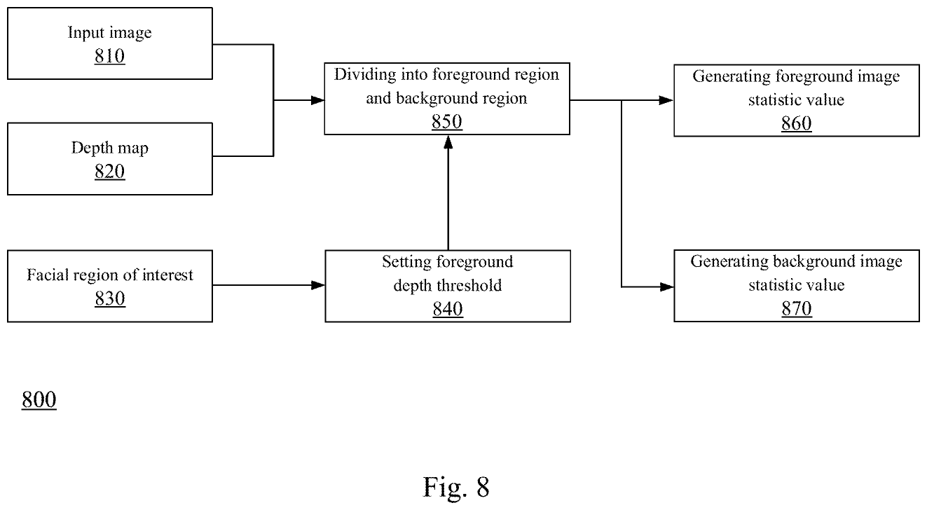

Please refer back to FIG. 2. Referring to step 230, performing a foreground and background image statistic on an input image and the depth map to generate a foreground image statistic value and a background image statistic value. For example, referring to step 810 of FIG. 8, providing an input image. Referring to step 820 of FIG. 8, providing a depth map. Referring to step 830 of FIG. 8, providing a facial region of interest (ROI).

Referring to step 840 of FIG. 8, setting a foreground depth threshold according to the facial region of interest. For example, the present disclosure can obtain a facial region of interest of the input image. Subsequently, an average depth value of the facial region of interest is calculated as the foreground depth threshold.

Referring to step 850 of FIG. 8, dividing the input image and the depth map into a foreground region and a background region according to the foreground depth threshold, and formulas are as follows:

Depth(i)>THD_{FG}: Depthₒᵤₜ(i)=255 Formula 9

Depth≤THD_{FG}: Depthₒᵤₜ(i)=0 Formula 10

As shown in Formulas 9 and 10, Depth(i) is the depth map, THD_{FG} is the foreground depth threshold, and Depthₒᵤₜ(i) is a customized depth image. If the pixel value of the depth map is larger than the foreground depth threshold, the pixel value is set to 255, that is, set to white. If the pixel value of the depth map is smaller than or equal to the foreground depth threshold, the pixel value is set to 0, that is, set to black, to generate the customized depth image. However, the present disclosure is not limited to the above embodiments, which are merely used to illustratively describe one implementation manner of the present disclosure.

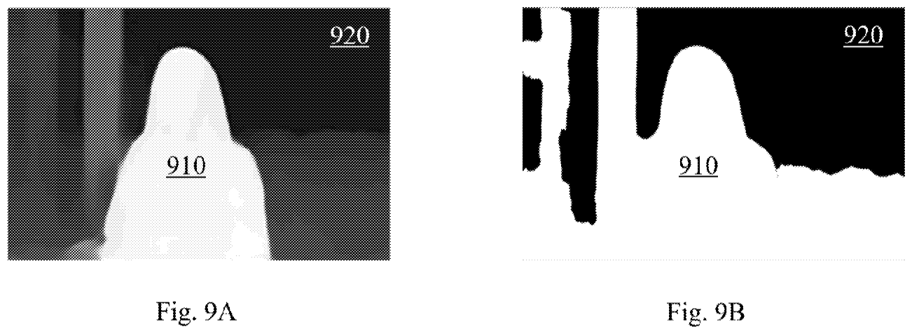

FIG. 9A shows an embodiment of a schematic diagram of a depth map of the present disclosure. FIG. 9B shows an embodiment of a schematic diagram of a customized depth image of the present disclosure. Referring to FIG. 9A and FIG. 9B, the depth map of FIG. 9A is redefined according to the foreground depth threshold to generate the customized depth image of FIG. 9B. As can be seen from FIG. 9B, a division between a foreground region 910 and a background region 920 is further enhanced.

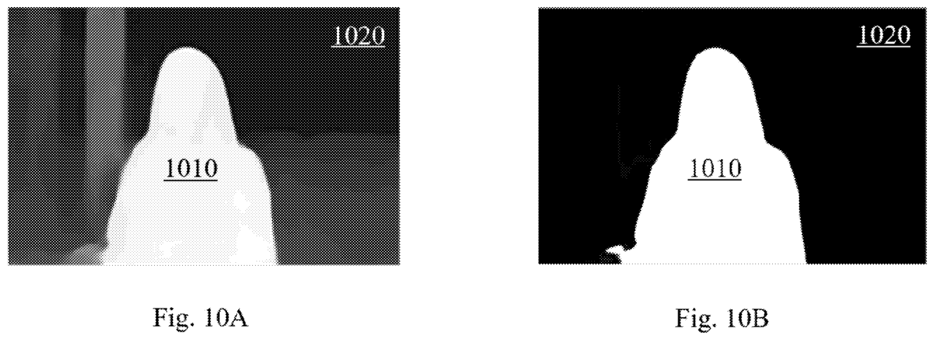

FIG. 10A shows an embodiment of a schematic diagram of a depth map of the present disclosure. FIG. 10B shows an embodiment of a schematic diagram of a customized depth image of the present disclosure. Referring to FIG. 10A and FIG. 10B, the depth map of FIG. 10A is redefined according to the foreground depth threshold and the facial region of interest to generate the customized depth image of FIG. 10B. As can be seen from FIG. 10B, only a foreground portion corresponding to the facial region of interest is divided, such that a division between a foreground region 1010 corresponding to a face and a background region 1020 is further enhanced.

Referring to steps 860 and 870 of FIG. 8, performing a foreground and background image statistic on the foreground region and the background region to generate the foreground image statistic value and the background image statistic value, and formulas are as follows:

Histogram(Depthₒᵤₜ,Image(i)): Formula 11

Depthₒᵤₜ=255: Calculation FG Histogram Formula 12

Depthₒᵤₜ=0: Calculation BG Histogram Formula 13

Brightness Histogram_{FG}=Histogram(Depthₒᵤₜ,255,Image(i)) Formula 14

Brightness Histogram_{BG}=Histogram(Depthₒᵤₜ,0,Image(i)) Formula 15

As shown in Formulas 11~15, Depthₒᵤₜ is the customized depth image, and Image(i) is the input image. If the pixel value of the customized depth image is 255, the pixel value is counted as the foreground image statistic value. If the pixel value of the customized depth image is 0, the pixel value is counted as the background image statistic value. In some embodiments, the present disclosure can calculate a foreground histogram Brightness Histogram_{FG} of the foreground region as the foreground image statistic value, and calculate a background histogram Brightness Histogram_{BG} of the background region as the background image statistic value. However, the present disclosure is not limited to the above embodiments, which are merely used to illustratively describe one implementation manner of the present disclosure.

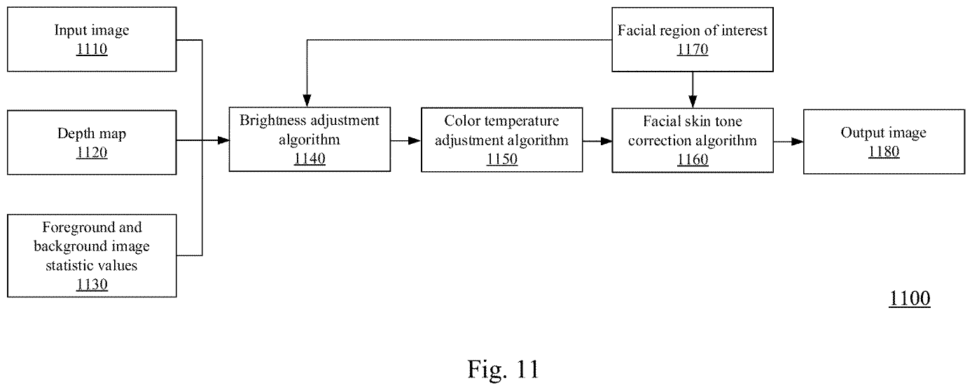

Please refer back to FIG. 2. Referring to step 240, performing a depth statistical image enhancement algorithm on the aerial perspective enhanced image, the foreground image statistic value, and the background image statistic value to generate an output image. For example, referring to step 1110 of FIG. 11, providing an input image. Referring to step 1120 of FIG. 11, providing a depth map. Referring to step 1130 of FIG. 11, providing the foreground image statistic value and the background image statistic value. Referring to step 1140 of FIG. 11, executing a brightness adjustment algorithm, and formulas are as follows:

(Histogram_{BG} Variance Histogram_{FG} Variance) and (Histogram_{BG} Average>Histogram_{FG} Average): Decrease AE Brightness Target to Enhance Dynamic Range Formula 16

(Histogram_{BG} Variance Histogram_{FG} Variance) and (Histogram_{BG} Averag>Histogram_{FG} Average): Increase AE Brightness Target to Enhance Dynamic Range Formula 17

As shown in Formulas 16 and 17, Histogram_{BG} Variance is a background variance of the background image statistic value, Histogram_{FG} Variance is a foreground variance of the foreground image statistic value, Histogram_{BG} Averag is a background mean value of the background image statistic value, and Histogram_{FG} Average is a foreground mean value of the foreground image statistic value. As shown in Formula 16, if the background variance of the background image statistic value is much smaller than the foreground variance of the foreground image statistic value, and the background mean value of the background image statistic value is larger than the foreground mean value of the foreground image statistic value, reducing an automatic exposure target brightness (AE Brightness Target) of the input image to enhance a dynamic range (Dynamic Range). As shown in Formula 17, if the background variance of the background image statistic value is much larger than the foreground variance of the foreground image statistic value, and the background mean value of the background image statistic value is larger than the foreground mean value of the foreground image statistic value, the automatic exposure target brightness (AE Brightness Target) of the input image is enhanced to enhance the dynamic range (Dynamic Range). However, the present disclosure is not limited to the above embodiments, which are merely used to illustratively describe one implementation manner of the present disclosure.

Referring to step 1150 of FIG. 11, executing a color temperature adjustment algorithm, and formulas are as follows:

RGB AWB FG Gain (Histogram_{FG})→Apply to Color Tuning FG Parameters with Depth Map Information Formula 18

RGB AWB BG Gain (Histogram_{BG})→Apply to Color Tuning BG Parameters with Depth Map Information Formula 19

As shown in Formulas 18 and 19, RGB AWB FG Gain (Histogram_{FG}) is a foreground automatic white balance gain, RGB AWB BG Gain (Histogram_{BG}) is a background automatic white balance gain, Color Tuning FG Parameters are foreground color tuning parameters, and Color Tuning BG Parameters are background color tuning parameters. As shown in Formula 18, the foreground automatic white balance gain is calculated according to the foreground image statistic value, and the foreground automatic white balance gain is applied to the foreground color tuning parameters. As shown in Formula 19, the background automatic white balance gain is calculated according to the background image statistic value (Histogram_{BG}), and the background automatic white balance gain is applied to the background color tuning parameters. However, the present disclosure is not limited to the above embodiments, which are merely used to illustratively describe one implementation manner of the present disclosure.

P_{FG}=AWB_{FG} (Input RGB Image) Formula 20

P_{BG}=AWB_{BG} (Input RGB Image) Formula 21

(Rₒᵤₜ,Gₒᵤₜ,Bₒᵤₜ)=W_{fg}*P_{FG}+W_{bg}*P_{BG} Formula 22

As shown in Formulas 20~22, P_{FG} is the foreground color tuning parameter, P_{BG} is the background color tuning parameter, Input RGB Image is RGB values of the input image, (Rₒᵤₜ, Gₒᵤₜ, Bₒᵤₜ) is the output image, W_{fg} is a foreground weight of the depth map, and W_{bg} is a background weight of the depth map. As shown in Formulas 20 and 21, a white balance algorithm is executed on RGB values of the input image to generate the foreground color tuning parameter P_{FG} and the background color tuning parameter P_{BG}. As shown in Formula 22, the output image (Rₒᵤₜ, Gₒᵤₜ, Bₒᵤₜ) is tuned according to the foreground weight W_{fg} of the depth map, the foreground color tuning parameter P_{FG}, the background weight W_{bg} of the depth map, and the background color tuning parameter P_{BG}. However, the present disclosure is not limited to the above embodiments, which are merely used to illustratively describe one implementation manner of the present disclosure.

Referring to step 1160 of FIG. 11, executing a facial skin tone correction algorithm. For example, the present disclosure can execute the facial skin tone correction algorithm according to a facial region of interest provided in step 1170. Referring to step 1180 of FIG. 11, providing an output image.

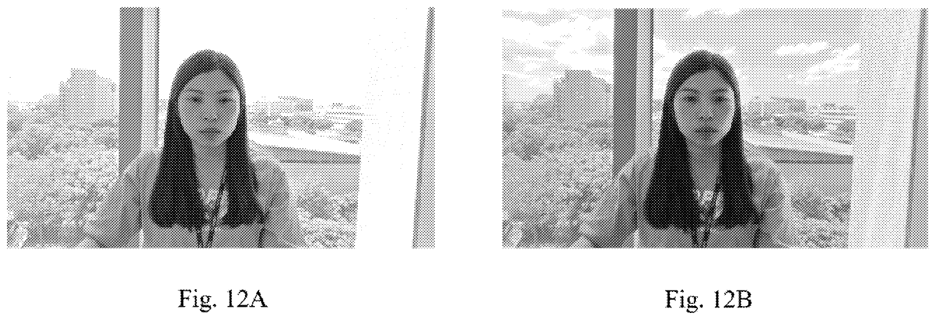

FIG. 12A shows an embodiment of a schematic diagram of an input image of the present disclosure. FIG. 12B shows an embodiment of a schematic diagram of a depth statistical enhanced image of the present disclosure. Referring to FIG. 12A and FIG. 12B, executing the depth statistical image enhancement algorithm on the input image of FIG. 12A to generate the depth statistical enhanced image of FIG. 12B. In addition to the aerial perspective image enhancement algorithm, the depth statistical image enhancement algorithm adopts image statistic values of the foreground and the background to respectively perform image enhancement for different depth maps, and enhances statistical guidance, to prevent a single statistical value from being applied to an entire frame of the input image, thereby causing partial image deviation or overall image deviation. Taking a backlight scene as an example, an outdoor window at a farther depth is a bright region, and an indoor portrait at a closer depth is a dark region. Through statistical guidance of the depth map, for example, automatic exposure (AE) and automatic white balance (AWB) strategies, the foreground region and the background region can be respectively processed with brightness enhancement for the indoor dark region and compensation for the outdoor bright region, thereby remedying a situation in conventional image processing where a dark region is excessively brightened and a bright region is suppressed. When a scene includes a complex mixed light source, the present disclosure can further optimize white balance tuning for different depth regions through depth-based region division.

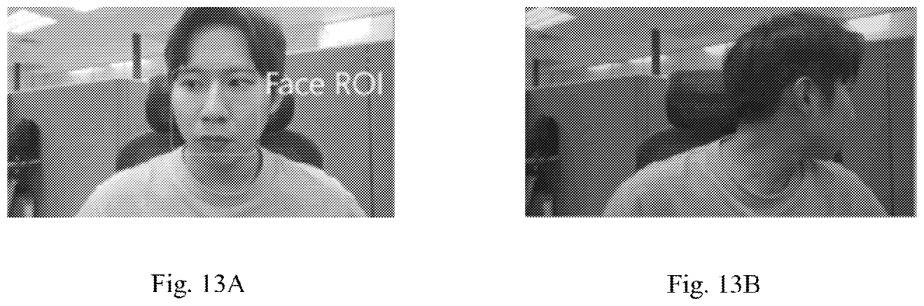

In some embodiments, by using the depth map in combination with a facial region of interest (ROI) for assistance, stability of 3A control (e.g., automatic exposure AE control, automatic white balance AWB control, and automatic focus AF control) can be enhanced, or facial skin tone can be tuned. Subsequently, taking automatic exposure AE control as an example, referring to FIG. 13A and FIG. 13B, FIG. 13A shows that a face is detected. However, when no face is detected in FIG. 13B, automatic exposure AE control becomes unstable, such as a significant decrease in brightness shown in FIG. 13B. In addition, face detection may fail or be unstable due to different brightness light sources, different skin tones, complex backgrounds, or changes in face angles. Whether face detection fails or is unstable, automatic exposure AE control becomes unstable.

To address the above problems, the present disclosure can refer to the depth map and historical face records to track a face position, thereby assisting the present disclosure in performing related determinations, so as to maintain the same automatic exposure AE control setting (e.g., maintaining the same exposure strategy), and optimize stability of automatic exposure AE control. The present disclosure can adopt a 3A stabilization algorithm, and a formula is as follows:

If Diff(Cur Depth_{ROI}−History Depth_{ROI})<Diff_{depth} THD:

Keep 3A Strategy Control Parameters and Global Brightness/Color Temperature/Clearity Formula 23

As shown in Formula 23, Cur Depth_{ROI} is a current depth map of the facial region of interest, History Depth_{ROI} is a historical depth map of the facial region of interest, and Diff_{depth} THD is a depth threshold. As shown in Formula 23, if a difference between the current depth map Cur Depth_{ROI} of the facial region of interest and the historical depth map History Depth_{ROI} of the facial region of interest is smaller than the depth threshold Diff_{depth} THD, the present disclosure maintains an automatic exposure parameter, an automatic white balance parameter, an automatic focus parameter, a brightness, a color temperature, and a sharpness of the input image. However, the present disclosure is not limited to the above embodiments, which are merely used to illustratively describe one implementation manner of the present disclosure.

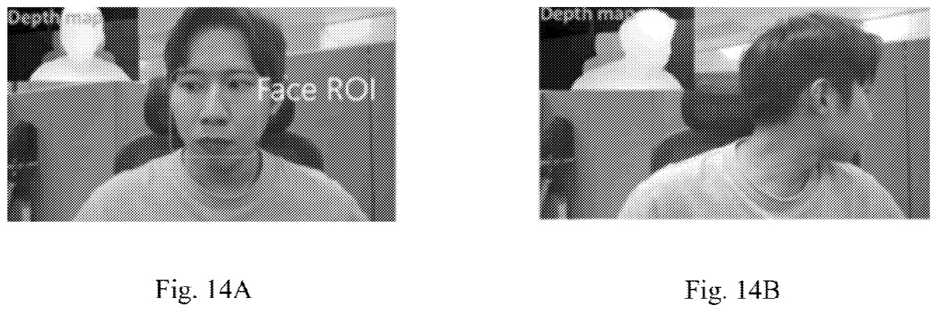

FIG. 14A shows an embodiment of a schematic diagram of an input image of the present disclosure. FIG. 14B shows an embodiment of a schematic diagram of an output image with automatic exposure control of the present disclosure. As shown in FIG. 14A and FIG. 14B, due to adoption of the 3A stabilization algorithm of the present disclosure, brightness of the two figures remains stable.

It should be noted that the present disclosure is not limited to the embodiments as shown in FIG. 1 to FIG. 14B, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The image adjusting method and the image adjusting device of the present disclosure can adopt an aerial perspective image enhancement algorithm to stereoscopically enhance a foreground region (e.g., a portrait) and to render a background region as distant, such that the foreground region (e.g., the portrait) is visually further stereoscopic and vivid. Furthermore, the image adjusting method and the image adjusting device of the present disclosure can adopt a depth statistical image enhancement algorithm to prevent a single statistical value from being applied to an entire frame of the input image, thereby causing an image deviation problem.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image adjusting method, executed by a processor, comprising:
providing a depth map;
performing an aerial perspective image enhancement algorithm on the depth map to generate an aerial perspective enhanced image;
performing a foreground and background image statistic on an input image and the depth map to generate a foreground image statistic value and a background image statistic value; and
performing a depth statistical image enhancement algorithm on the aerial perspective enhanced image, the foreground image statistic value, and the background image statistic value to generate an output image.

2. The image adjusting method of claim 1, wherein providing the depth map comprises:
performing a downscaling step on the input image to generate a downscaled image;
performing a depth estimation on the downscaled image to generate the depth map;
performing a normalization on the depth map such that the depth map is within a numerical range; and
performing a temporal smoothing algorithm on the depth map according to a historical input image and a historical depth map.

3. The image adjusting method of claim 1, wherein performing the aerial perspective image enhancement algorithm on the depth map to generate the aerial perspective enhanced image comprises:
calculating a weight according to the depth map;
generating a brightness contrast according to the weight, a local brightness map of the input image, and a brightness and contrast enhancement curve;
generating a color saturation according to the weight, a saturation scaling coefficient, and a color component of the input image;
generating a detail strength control coefficient according to the brightness contrast, the weight, a texture scaling coefficient, and a brightness difference of the input image; and
generating the aerial perspective enhanced image according to the brightness contrast, the color saturation, and the detail strength control coefficient.

4. The image adjusting method of claim 3, wherein performing the aerial perspective image enhancement algorithm on the depth map to generate the aerial perspective enhanced image further comprises:
generating a preferred color coefficient according to the weight, a style color offset scaling coefficient, and the color component of the input image;
generating a noise reduction strength control coefficient according to a maximum depth value of the depth map, the weight, a strong noise reduction color space parameter, and a weak noise reduction color space parameter; and
generating the aerial perspective enhanced image according to the brightness contrast, the color saturation, the detail strength control coefficient, the preferred color coefficient, and the noise reduction strength control coefficient.

5. The image adjusting method of claim 1, wherein performing the foreground and background image statistic on the input image and the depth map to generate the foreground image statistic value and the background image statistic value comprises:
setting a foreground depth threshold according to a facial region of interest;
dividing the input image and the depth map into a foreground region and a background region according to the foreground depth threshold; and
performing the foreground and background image statistic on the foreground region and the background region to generate the foreground image statistic value and the background image statistic value.

6. The image adjusting method of claim 5, wherein setting the foreground depth threshold according to the facial region of interest comprises:
obtaining the facial region of interest of the input image; and
calculating an average depth value of the facial region of interest as the foreground depth threshold.

7. The image adjusting method of claim 6, wherein performing the foreground and background image statistic on the foreground region and the background region to generate the foreground image statistic value and the background image statistic value comprises:
calculating a foreground histogram of the foreground region as the foreground image statistic value; and
calculating a background histogram of the background region as the background image statistic value.

8. The image adjusting method of claim 1, wherein performing the depth statistical image enhancement algorithm according to the aerial perspective enhanced image, the foreground image statistic value, and the background image statistic value to generate the output image comprises:
if a background variance of the background image statistic value is smaller than a foreground variance of the foreground image statistic value, and a background mean value of the background image statistic value is larger than a foreground mean value of the foreground image statistic value, reducing an automatic exposure target brightness of the input image to enhance a dynamic range; or
if the background variance of the background image statistic value is larger than the foreground variance of the foreground image statistic value, and the background mean value of the background image statistic value is larger than the foreground mean value of the foreground image statistic value, enhancing the automatic exposure target brightness of the input image to enhance the dynamic range.

9. The image adjusting method of claim 1, wherein performing the depth statistical image enhancement algorithm according to the aerial perspective enhanced image, the foreground image statistic value, and the background image statistic value to generate the output image comprises:
calculating a foreground automatic white balance gain according to the foreground image statistic value, and applying the foreground automatic white balance gain to a foreground color tuning parameter;
calculating a background automatic white balance gain according to the background image statistic value, and applying the background automatic white balance gain to a background color tuning parameter; and
tuning the output image according to a foreground weight of the depth map, the foreground color tuning parameter, a background weight of the depth map, and the background color tuning parameter.

10. The image adjusting method of claim 1, further comprising:
if a difference between a current depth map of a facial region of interest and a historical depth map of the facial region of interest is smaller than a depth threshold, maintaining an automatic exposure parameter, an automatic white balance parameter, an automatic focus parameter, a brightness, a color temperature, and a sharpness of the input image.

11. An image adjusting device, comprising:
a processor, configured to execute at least one command to:
provide a depth map;
perform an aerial perspective image enhancement algorithm on the depth map to generate an aerial perspective enhanced image;
perform a foreground and background image statistic on an input image and the depth map to generate a foreground image statistic value and a background image statistic value; and
perform a depth statistical image enhancement algorithm on the aerial perspective enhanced image, the foreground image statistic value, and the background image statistic value to generate an output image.

12. The image adjusting device of claim 11, wherein the processor is configured to execute the at least one command to:
perform a downscaling step on the input image to generate a downscaled image;
perform a depth estimation on the downscaled image to generate the depth map;
perform a normalization on the depth map such that the depth map is within a numerical range; and
perform a temporal smoothing algorithm on the depth map according to a historical input image and a historical depth map.

13. The image adjusting device of claim 11, wherein the processor is configured to execute the at least one command to:
calculate a weight according to the depth map;
generate a brightness contrast according to the weight, a local brightness map of the input image, and a brightness and contrast enhancement curve;
generate a color saturation according to the weight, a saturation scaling coefficient, and a color component of the input image;
generate a detail strength control coefficient according to the brightness contrast, the weight, a texture scaling coefficient, and a brightness difference of the input image; and
generate the aerial perspective enhanced image according to the brightness contrast, the color saturation, and the detail strength control coefficient.

14. The image adjusting device of claim 13, wherein the processor is configured to execute the at least one command to:
generate a preferred color coefficient according to the weight, a style color offset scaling coefficient, and the color component of the input image;
generate a noise reduction strength control coefficient according to a maximum depth value of the depth map, the weight, a strong noise reduction color space parameter, and a weak noise reduction color space parameter; and
generate the aerial perspective enhanced image according to the brightness contrast, the color saturation, the detail strength control coefficient, the preferred color coefficient, and the noise reduction strength control coefficient.

15. The image adjusting device of claim 11, wherein the processor is configured to execute the at least one command to:
set a foreground depth threshold according to a facial region of interest;
divide the input image and the depth map into a foreground region and a background region according to the foreground depth threshold; and
perform the foreground and background image statistic on the foreground region and the background region to generate the foreground image statistic value and the background image statistic value.

16. The image adjusting device of claim 15, wherein the processor is configured to execute the at least one command to:
obtain the facial region of interest of the input image; and
calculate an average depth value of the facial region of interest as the foreground depth threshold.

17. The image adjusting device of claim 16, wherein the processor is configured to execute the at least one command to:
calculate a foreground histogram of the foreground region as the foreground image statistic value; and
calculate a background histogram of the background region as the background image statistic value.

18. The image adjusting device of claim 11, wherein the processor is configured to execute the at least one command to:
if a background variance of the background image statistic value is smaller than a foreground variance of the foreground image statistic value, and a background mean value of the background image statistic value is larger than a foreground mean value of the foreground image statistic value, reduce an automatic exposure target brightness of the input image to enhance a dynamic range; or
if the background variance of the background image statistic value is larger than the foreground variance of the foreground image statistic value, and the background mean value of the background image statistic value is larger than the foreground mean value of the foreground image statistic value, enhance the automatic exposure target brightness of the input image to enhance the dynamic range.

19. The image adjusting device of claim 11, wherein the processor is configured to execute the at least one command to:
calculate a foreground automatic white balance gain according to the foreground image statistic value, and apply the foreground automatic white balance gain to a foreground color tuning parameter;
calculate a background automatic white balance gain according to the background image statistic value, and apply the background automatic white balance gain to a background color tuning parameter; and
tune the output image according to a foreground weight of the depth map, the foreground color tuning parameter, a background weight of the depth map, and the background color tuning parameter.

20. The image adjusting device of claim 11, wherein the processor is configured to execute the at least one command to:
if a difference between a current depth map of a facial region of interest and a historical depth map of the facial region of interest is smaller than a depth threshold, maintain an automatic exposure parameter, an automatic white balance parameter, an automatic focus parameter, a brightness, a color temperature, and a sharpness of the input image.
